(19) United States
(12) Patent Application Publication
(10) Pub. No.: US 2005/0221705 A1
(43) Pub. Date: Oct. 6, 2005

(54) Nonwoven fiber mats with smooth surfaces and method

(76) Inventor: James Matthew Hitch, Niota, TN (US)

Correspondence Address: Robert D. Touslee;Johns Manville, 10100 West Ute Avenue, Littleton, CO, 80127, US

(21) Appl. No.: 10/812,457

(22) Filed: Mar. 30, 2004

(51) Int. Cl. B32B 5/18; B32B 17/02; B32B 17/04

(52) U.S. Cl. 442/180; 162/157.1; 162/157.2; 162/156; 162/164.2; 442/415

(57) ABSTRACT

A fibrous nonwoven mat particularly suited for coating to form a facer mat is disclosed along with laminates containing the mat and the method of making the mat. The fiber in the mat can be glass fibers or synthetic polymer fibers or mixtures thereof and comprise two lengths of fibers in the range of about 0.12 to about 0.8 inches long and the fibers are bound together with a resin binder. The mats of the present invention have fewer “stand up” fibers than prior art mats made using 9-14 micron fiber.

The present invention involves nonwoven mats having a smooth surface and good properties for use in making coated mats for facing products like foam board, gypsum board, various types of wood boards, etc., and the method of making these mats. These mats are also useful as reinforcement and dimensional stabilizers for making a large number of products such as insulation composites or laminates of all types and for many uses. The mats are also useful as stabilizing and reinforcing substrates for other products such as fiberglass duct board and the like.

### BACKGROUND

It is known to make reinforcing nonwoven mats from fibers like glass and/or synthetic polymer fibers and to use these mats as substrates in the manufacture of a large number of products. Methods of making nonwoven mats are known, such as conventional wet laid processes described in U.S. Pat. Nos. 4,112,174, 4,681,802 and 4,810,576, the disclosures of which are hereby incorporated herein by reference.

Urea formaldehyde resins, usually modified with one or more of acrylic, styrene butadiene, or vinyl acetate resins, are conventionally used as a binder for the fibers in the mats because of their suitability for the applications and their relatively low cost. The binder content of these finished mats typically are in the range of 15 to 25 weight percent or higher, based on the dry weight of the mat. It is also known to use other types of aqueous latex binders like acrylics, polyester, polyvinyl acetate, polyvinyl alcohol and other types of resinous binders alone or in combination.

Nonwoven fibrous mats containing glass fibers having average fiber diameters of about 10 to about 16 microns have been used as facers for glass fiber insulation blanket, pressed glass fiber insulation boards, duct liner, foam board, gypsum board and various wood board products. It is also known to increase the hiding power and reduce bleed through of foam by adding a minor portion of very small diameter glass microfibers, having average diameters of about 2 microns or less, but this adds considerable cost to the mat, makes the mat weaker and fuzzier and increases the amount of scrap when making this mat due to wrinkling problems.

It is also disclosed in U.S. Pat. Nos. 5,001,005 and 5,965,257 to make glass fiber mats containing 60-90 weight percent glass fibers 10-40 percent of non-glass filler material and 1-30 percent of a non-asphaltic binder to use as a facer for a foam substrate. The filler materials are bonded to the glass fibers with the binder and prevent bleed through of the foam precursor materials when the latter is placed in contact with the mat prior to blowing.

The mats described above have a small amount of “stand up” fibers that are undesirable, at least use as facers for certain products like gypsum board and foam board, etc., particularly on boards having a faced side that will later be painted as an interior of a building. The “stand up” fibers cause some irritation when the faced boards are handled without gloves or arm covering and these fibers also interfere with the painting process and detract from the appearance of the painted surface.

It is known, as illustrated by U.S. Pat. No. 5,965,257, to make a mat having zero bleed through when used as a facer mat in the manufacture of foam insulation by heavily coating a dry, bonded mat on a separate coating line. This patent teaches a coating composition comprising one or more fillers and a binder like acrylic latex. It is also known to use off-line coating to make mats having good hiding and painting properties since the heavy coating surrounds and holds down the “stand up” fibers, but the thick coating required adds considerable cost to the product. If there were fewer “stand up” fibers and if the ends of these fibers were closer to the surface of the mat, substantially less coating material would be required.

### SUMMARY OF THE INVENTION

Nonwoven mats of the present invention comprise glass or synthetic polymer fibers bonded together with an aqueous binder system containing a non-formaldehyde resin binder, preferably a combination of water and a binder like an acrylic, with or without a crosslinking agent, polyvinyl alcohol, hydroxyl ethyl cellulose, carboxyl methyl cellulose, cellulose gums, polyvinyl pyrilidone, polyvinyl acetate, etc.

The preferred fiber is glass fiber having an average fiber diameter in the range of about 9 to about 14 microns, preferably about 9 to about 11 microns. Other fibers including synthetic fibers like nylon, polyester, polyethylene, etc. can be present in amounts up to 100 percent of the fibers. The length of the glass fibers can be from about 0.12 inch to about 0.8 inch, preferably from about 0.2 inch to about 0.6 inch. The fiber is preferably in combinations of lengths, and it is preferred to use combinations of short fiber like 0.12 or 0.2 inch fiber with longer fibers to optimize smoothness and cost, since the shorter the fiber, the higher its cost, while at the same time minimizing the amount of “stand up” fibers. By using shorter fibers, a mat having smaller pores at the surface is produced than mats made from 0.7 inch to about 1.2 inch long fibers since there are more fibers per unit weight of fibers. Preferably a major portion of the fiber is at least about 0.45 inch long and a minor portion of the fiber is shorter than about 0.4 inch.

The present invention also includes laminates comprising a layer the mats according to the invention bonded onto another layer comprising another mat, gypsum board, foam board, a board of a wood product including particle board, oriented strand board, chip board, plywood, high pressure laminates, a layer of thermoplastic or thermoset polymer, or a layer of fibrous insulation product.

The present invention also includes a method of making the novel nonwoven fiber mats described above from a slurry of fiber, preferably glass fiber, comprising forming a nonwoven web on a moving, permeable surface and thereafter saturating the fibrous web with an aqueous resin based binder, preferably an acrylic resin binder with or without a cross-linking agent, containing 15-25 weight percent, preferably 18-22 wt. percent, based on the dry weight of the finished mat, removing excess aqueous binder and drying and curing the mat in an oven. The resultant mat is normally wound into rolls and packaged for shipment, and/or transported to a point of use.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### DETAILED DESCRIPTION OF THE INVENTION

A slurry of fibers is made by adding the fibers, having an average fiber diameter from about 9 to about 14 microns and lengths, preferably a blend of two lengths, of from about 0.12 to about 0.8 inch, preferably 0.2 to 0.6 inch, long, to a conventional wet process white water in a pulper to disperse the fibers forming a slurry having a typical fiber concentration of about 0.2-1.0 weight percent. The slurry is then metered into a flow of the white water to dilute the fiber concentration to about 0.1 wt. percent or less after which this dilute slurry is then deposited onto a moving screen forming wire to dewater and form a wet nonwoven fibrous mat.

This wet nonwoven web of fiber is then transferred to a second moving screen in-line with the forming screen and run through a binder application saturating station where an aqueous binder mixture, such as an aqueous acrylic resin, is applied to the mat in any one of several known ways. The binder saturated mat is then run over a suction section while still on the moving screen to remove excess binder. Preferably, the aqueous binder solution is applied using a curtain coater or a dip and squeeze applicator, but other methods of application such as spraying are also known.

The wet mat is then transferred to a wire mesh moving belt and run through an oven to dry the wet mat and to cure the resin binder, in this case an acrylic, which bonds the fibers together in the mat. In the drying and curing oven the mat is subjected to temperatures up to 350-500 degrees F. or higher for periods usually not exceeding 1-2 minutes and as little as a few seconds.

The binders used to bond the fibers together are preferably resins that can be put into aqueous mixtures or emulsion latex. Typical resin based binders meeting this description are acrylics, with or without cross-linking agents, polyvinyl alcohol, carboxyl methyl cellulose, hydroxyl ethyl cellulose, lignosulfonates, urea formaldehyde resins modified in known manner to plasticize the binder and to provide higher wet strengths, cellulose gums and other similar resins. Of these, conventional modified urea formaldehyde resins are much preferred from a cost standpoint, and bonding strength to fibers, particularly glass fibers. Unfortunately, acceptance is not always as good as the functional suitability of this binder for various applications. A preferred acrylic resin commercially available is Noveon™ 26138 acrylic emulsion available from Noveon Corp. of Cleveland, Ohio.

The mats of the present invention are particularly suited for coating with various conventional coating compositions and the resultant coated mats make good facers for various board products as described earlier. The nonwoven fiber glass mats of the invention have much larger pores between the fibers than various papers as evidenced by very high air permeability in the mats compared to paper and as evidenced by the manner in which an aqueous binder is applied to the newly formed wet web of glass fiber, i.e. by flowing a substantial excess of binder through the mat in a very short time, within a few feet while the mat is moving at several hundred feet per minute, and then removing excess binder from the mat by running the mat over a suction slot. If the permeability of the wet web is not substantially higher than that of paper, the binder will tend to puddle on the surface and not flow the mat. It is for this reason that glass fiber mat is not “coated” wet in the manner used for papers.

Processes for making nonwoven fiberglass mats are well known and some of them are described in U.S. Pat. Nos. 4,112,174, 4,681,802 and 4,810,576, which references are hereby incorporated into this disclosure by reference, but any known method of making nonwoven mats can be used. The preferred technique for the making of mats of the present invention is forming a dilute aqueous slurry of fibers and depositing the slurry onto an inclined moving screen forming wire to dewater the slurry and form a wet nonwoven fibrous mat, on machines like a Hydroformer™ manufactured by Voith-Sulzer of Appleton, WS, or a Deltaformer™ manufactured by Valmet/Sandy Hill of Glenns Falls, N.Y. The examples disclosed herein were made on a pilot scale model of a wet forming machine, binder applicator, and oven that produces a mat very similar to a mat that would be produced from the same slurry and binder on a production sized Voith-Sulzer Deltaformer™ with a curtain coater binder applicator and a flat bed, permeable conveyor type convection dryer.

### EXAMPLE 1

A fiber slurry was prepared in a well known manner by adding one half inch long wet H137 E type glass chopped fiber available from Johns Manville of Denver, Colo. The fiber had diameters averaging about 10-11 microns to a known cationic white water containing Natrosol™ thickening agent available from Hercules, Inc. and a cationic surfactant C-61, an ethoxylated tallow amine available from Cytec Industries, Inc. of Morristown, N.J., as a dispersing agent to form a slurry having a conventional fiber concentration. After allowing the slurry to agitate for about 20 minutes to thoroughly disperse the fibers, the slurry was metered into a moving stream of the same whitewater to dilute the fiber concentration to conventional concentration weight percent before pumping the diluted slurry to a headbox of a pilot sized machine similar to a Voith Hydroformer™ where a wet nonwoven mat was continuously formed.

The wet mat was removed from the forming wire and transferred to a Sandy Hill type curtain coater where a conventional aqueous Noveon™ 26138 acrylic resin aqueous emulsion was applied in an amount to provide a binder level in the cured mat of about 20 weight percent. The wet mat was then transferred to an oven belt and carried through an oven to dry the mat and to fully cure the binder resin to a temperature of about 300-450 degrees F. This mat is a conventional and control mat. The basis weight of the mat produced was 1.21 lbs./100 sq. ft. This mat is suitable for coating applications.

### EXAMPLE 2

Another mat was made in the same manner as used in Example 1 except that a blend of different fiber lengths was used for the fiber. The fiber blend contained about 75 wt. percent one-half inch long H137 fibers and about 25 wt. percent H137 fibers that were about 0.2 inch long. The type and amount of binder were the same as in the mat of Example 1. The finished mat of this Example 2 had a basis weight of about 1.2 lbs./100 sq. ft. This mat also appeared to have a smoother surface than the mat of Example 1. This mat was for applying a coating and the thickness of the coating could possibly be reduced versus the coating on the mat made in Example 1.

### EXAMPLE 3

Another mat was made in the same manner as used in Example 2 except the fiber blend contained about 50 wt. percent H137 fibers having a length of about 0.5 inch long and about 50 wt. percent H137 fibers that were about 0.2 inch long. The type and amount of binder was the same as Examples 1 and 2. The finished mat had a basis weight of about 1.2 lbs./100 sq. ft. and had substantially fewer “stand up” fibers and a smoother surface than the mat of Example 2. This mat was for applying a coating and the thickness of the coating could be minimized because of the improved nature and reduced amount of the “stand up” fibers.

Having the benefit of the above disclosure, many other modifications will be obvious to the skilled artisan, all of which are intended to be included in the scope of the following claims.

1. A nonwoven fibrous mat comprising a blend of fibers of at least two different lengths falling within the range of about 0.12 inch and about 0.6 inch bound together with a cured binder, the binder content of the mat being in the range of about 10-25 weight percent of the finished mat, the fibers having an average fiber diameter in the range of about 9 and about 14 microns.

2. The mat of claim 1 wherein the binder is selected from a group consisting of an acrylic, a polyvinyl alcohol, a hydroxyl ethyl cellulose, a carboxyl methyl cellulose, a cellulose gums, a polyvinyl pyrilidone, polyvinyl acetate, urea formaldehyde, melamine formaldehyde, with or without a crosslinking agent, with or without one or more plasticizers, and mixtures thereof.

3. The mat of claim 1 wherein about half of the fiber is at least about 0.45 inch long and a remainder of the fiber is less than about 0.4 inch long.

4. The mat of claim 1 wherein the mat contains about 75 wt. percent fiber that is at least about 0.45 inch lone and about 25 wt. percent fiber that is about 0.2 inch long.

5. A laminate comprising a layer of nonwoven fiber mat comprising a blend of fibers of at least two different lengths falling within the range of about 0.12 inch and about 0.8 inch bound together with a cured binder, the binder content of the mat being in the range of about 10-25 weight percent of the finished mat, the fibers having an average fiber diameter in the range of about 9 and about 14 microns, a surface of said mat being bonded to at least one layer of different material.

6. The laminate of claim 5 wherein the binder is selected from a group consisting of an acrylic, a polyvinyl alcohol, a hydroxyl ethyl cellulose, a carboxyl methyl cellulose, a cellulose gums, a polyvinyl pyrilidone, polyvinyl acetate, urea formaldehyde, melamine formaldehyde, with or without a crosslinking agent, with or without one or more plasticizers, and mixtures thereof.

7. The laminate of claim 5 wherein about half of the fiber is at least about 0.45 inch long and a remainder of the fiber is less than about 0.4 inch long.

8. The mat of claim 5 wherein the mat contains about 75 wt. percent fiber that is at least about 0.45 inch long and about 25 wt. percent fiber that is about 0.2 inch long.

9. A method of making a nonwoven fibrous mat comprising a blend of fibers of at least two different lengths falling within the range of about 0.12 inch and about 0.6 inch, the fibers having an average fiber diameter in the range of about 9 and about 14 microns comprising making an aqueous slurry of the fibers, forming a wet web of the fibers from the slurry, applying an aqueous binder to the wet web and removing excess binder to produce an Loss On Ignition in the finished mat of about 10-25 weight percent, and drying the mat and curing the binder.

10. The method of claim 9 wherein the binder is selected from a group consisting of an acrylic, a polyvinyl alcohol, a hydroxyl ethyl cellulose, a carboxyl methyl cellulose, a cellulose gums, a polyvinyl pyrilidone, polyvinyl acetate, urea formaldehyde, melamine formaldehyde, with or without a crosslinking agent, with or without one or more plasticizers, and mixtures thereof.

11. The method of claim 9 wherein a major portion of the fiber is at least about 0.45 inch long and a minor portion of the fiber is less than about 0.4 inch long.

12. The method of claim 9 wherein the mat contains about 75 wt. percent fiber that is at least about 0.45 inch long and about 25 wt. percent fiber that is about 0.2 inch long.

13. The method of claim 9 wherein about half of the fiber is at least about 0.45 inch long and a remainder of the fiber is less than about 0.4 inch long.

14. The mat of claim 1 wherein about half of the fiber is at least about 0.45 inch long and a remainder of the fiber is less than about 0.4 inch long.

15. The laminate of claim 5 wherein about half of the fiber is at least about 0.45 inch long and a remainder of the fiber is less than about 0.4 inch long.
